(19) United States
(12) Patent Application Publication
(10) Pub. No.: US 2023/0038749 A1
(43) Pub. Date: Feb. 9, 2023

(54) SELF-CHECKING DIAGNOSTICS FRAMEWORK FOR MULTICAST LOGIC IN A PACKET FORWARDING DEVICE

(71) Applicant: Intel Corporation, Santa Clara, CA (US)

(72) Inventors: Sachin BAHADUR, Santa Clara, CA (US); Anurag AGRAWAL, Santa Clara, CA (US)

(21) Appl. No.: 17/957,992

(22) Filed: Sep. 30, 2022

Related U.S. Application Data
(60) Provisional application No. 63/356,957, filed on Jun. 29, 2022.

(51) Int. Cl. H04L 49/113; H04L 45/7453

(52) U.S. Cl. CPC H04L 49/113; H04L 45/7453

(57) ABSTRACT

Examples described herein relate to a network interface device that includes circuitry that is to: receive a packet; replicate the packet based on a multicast configuration; and determine a number of replicate packets that differ from the received packet. In some examples, circuitry is to receive hash value that comprises a hash of a portion of the packet and circuitry is to determine a hash value of the replicated packet.

### RELATED APPLICATION

This application claims priority to U.S. Provisional Application No. 63/356,957, filed Jun. 29, 2022. The entire contents of that application is incorporated by reference in its entirety.

### BACKGROUND

FIG. 1 depicts ail example of a unicast test. A central processing unit (CPU) can generate packets to be injected to the forwarding chip as unicast packets. Media access control (MAC) ports can be placed in loopback mode so that packets looping through the system to stress the system. Packets egressing the MAC can be made available to the CPU so that the CPU can verify integrity of the packets. However, as the number of different packets that are injected into the system increase, the burden on the CPU to verify integrity of packets can increase, potentially leading to the CPU not processing the packets quickly enough and slowing down packet throughput.

### BRIEF DESCRIPTION OF THE DRAWINGS

FIG. 1 depicts an example of packet unicast.

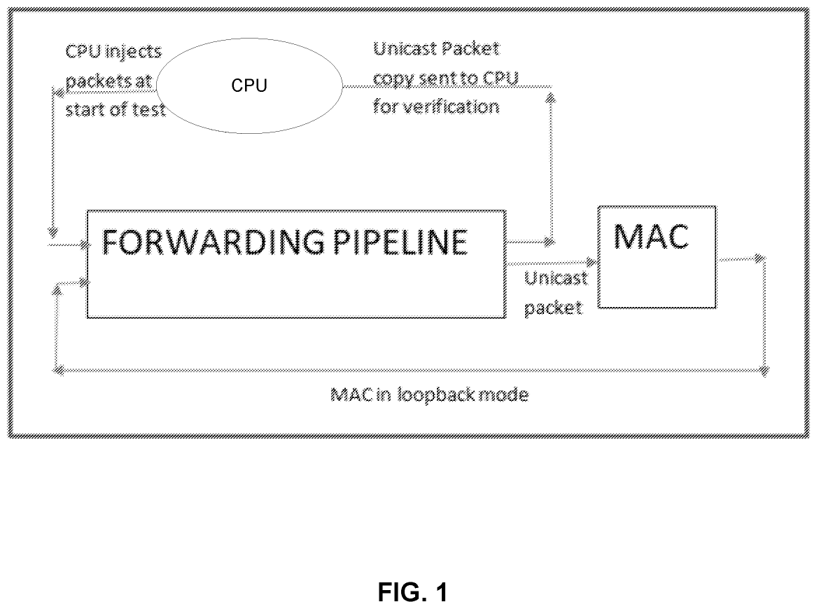

FIG. 2 depicts an example system to perform a multicast test.

FIG. 3 shows parameters of a diagnostic test framework.

FIG. 4 depicts an example of a forwarding element.

FIG. 5 depicts an example of checksum verify.

FIG. 6 depicts an example process for framework final verification.

FIG. 7 depicts an example network interface device.

FIG. 8 depicts an example packet processing pipeline.

FIG. 9 depicts an example system.

FIG. 10 depicts an example system.

### DETAILED DESCRIPTION

In a multicast operation, if there are thousands of incoming packets, then replication of those packets can burden the CPU to verify millions of packets. Block level multicast testing can be performed in a lab that does not stress the CPU, but does not utilize packets that would be transmitted and may not test flip flops and wire connections of a forwarding element device at the physical design (PD) level.

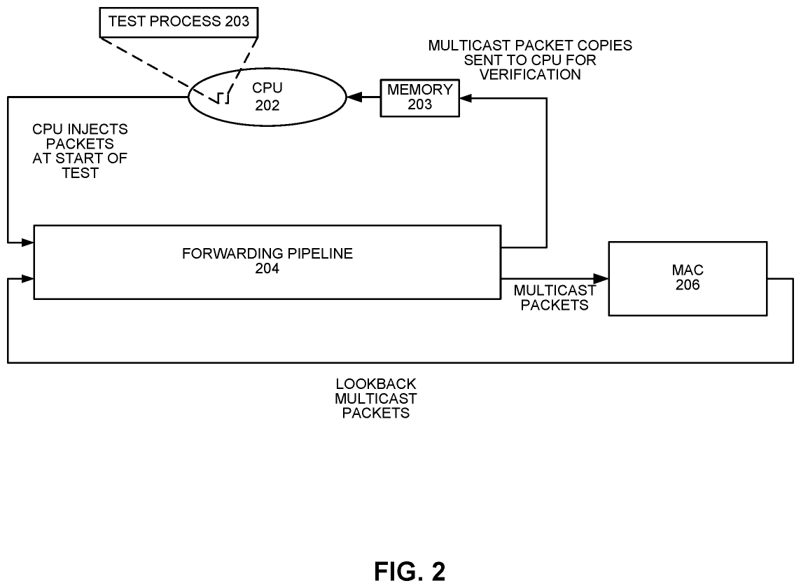

FIG. 2 depicts an example system to perform a multicast test. CPU 202 can execute test process 203 to form and provide test packets to forwarding pipeline 204 at or prior to a start of a test. Forwarding pipeline 204 can replicate the test packets to generate a multicast operation for the test. Test process 203 can set one or more media access control (MAC) ports of MAC 206 to loopback mode to cause the multicast packets to loop back to forwarding pipeline 204 after transmission of the multicast packets. Test process 203 can configure forwarding pipeline 204 to copy packets egressing MAC 206 to memory 203 accessible to CPU 202 so that test process 203 can verify data integrity of multicast packets.

At least to perform testing of a network interface device (e.g., switch, network processor (NPU), network interface controller, or others) of packet multicast operations with chip-based multicast circuitry. Multicast circuitry can be configured to provide multicast packet stress on the network interface device. The network interface device can include diagnostic circuitry to screen multicast circuitry in a packet forwarding chip in a lab or while being used by a customer to identify errors in one or more packets replicated for a multicast operation. Multicast and diagnostic circuitry can generate packets and can verify multicast traffic at line-rate. Based on the testing, diagnostics on the network interface device can be performed to verify that multicast circuitry of the network interface device accurately replicated packets and to determine whether manufacturing defects are present in the network interface device. Note that references to multicast can instead or in addition, refer to broadcast operations.

A packet can be associated with one or more multicast groups. To verify packets generated for multicast, an ingress parser of the network interface device can calculate a checksum of a packet and circuitry of the network interface device can compare the checksum against checksums calculated for replica packets that are part of a multicast group. Based on checksum values not matching, an error count can be incremented. The error count can refer to a particular test packet or a group of test packets.

To cause multicasting of packets and count errors based on differences from replica packets and the test packet, a diagnostics framework software development environment (SDE) can be utilized based on one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

Some examples provide: 1) multicast packet validation on switch silicon to verify generated multicast packet for data integrity; 2) framework that can be run without any packet generator such as Ixia without need to connect any external cables; 3) framework that can identify errors in multicast operations without redirecting packets to an external collector or packet generator; and/or 4) multicast packet verification at line-rate of a network interface device.

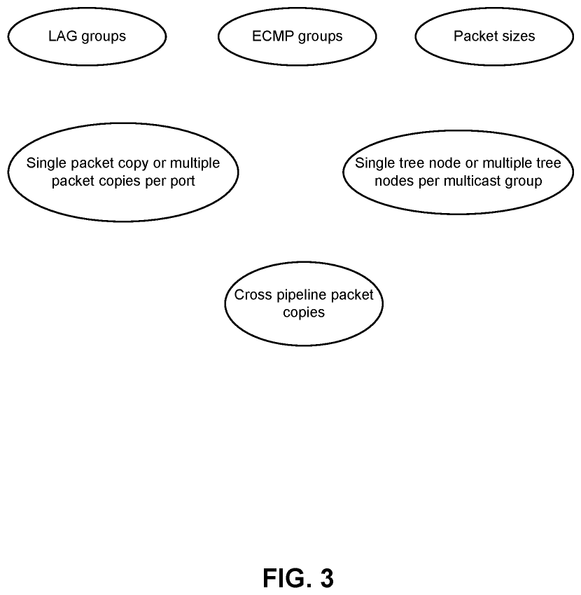

FIG. 3 shows examples of parameters that can be applied by a diagnostic test framework performed by a packet processing pipeline for multicast operations. For example, a particular link aggregation group (LAG) can be specified for a packet. An equal-cost multi-path routing (ECMP) group can be specified for the packet. Various packet sizes can be specified with various lengths, various number of header fields, various header sizes, various payload sizes, and so forth. Specification of single packet copy or multiple packet copy per port can be set for the packet. Specification of single tree node or multiple tree nodes per multicast group can be set for the packet. Cross pipeline packet copy traversals can be set to specify whether the packet from an ingress pipeline can egress a different egress pipeline. For example, cross pipeline packet can specify whether a packet from ingress pipeline 0 can be provided to egress pipeline 1 or 2.

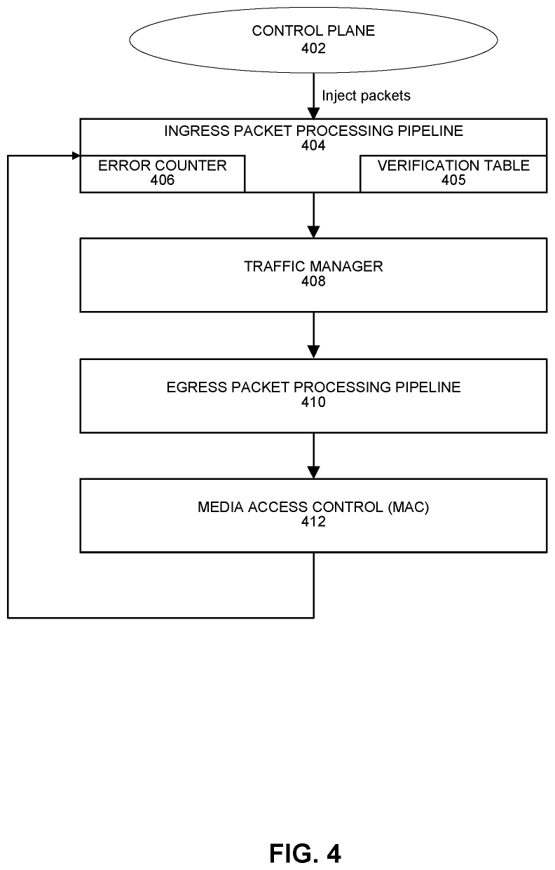

FIG. 4 depicts an example of circuitry that can be used in a network interface device. Control plane 402 can set up a diagnostic framework to stress the circuitry in the network interface device with one or more variations of loads. In some examples, control plane 402 can be implemented as software executed by a processor in a server or a processor in the forwarding element. At (1), control plane 402 can setup one or more MAC ports in MAC loopback mode. At (2), control plane 402 can assign one or more ports of ingress packet processing pipeline 404 as a primary port and assign one or more ports of egress packet processing pipeline 410 as a primary port. For example, one or more ingress and egress ports can be assigned as a primary port. Control plane 402 can provide a test packet to an ingress primary port for circulation through a forwarding element and egress from a primary egress port. Secondary egress ports can egress replicas or copies of the test packet and secondary ingress ports can receive replicas or copies of the test packet.

At (3), based on a configuration from control plane 402, traffic manager 408 associated with the primary ingress port can create multicast packet copies based on multicast group identifier. For example, match-action circuitry can perform operations to create copies of the packet to provide as a multicast operation. Traffic manager 408 can access a multicast group identifier for the packet to identify a single tree node that includes pointers to LAG, ECMP, and secondary ports to egress replicas of the packet. A primary port may not create multicast copies to other primary ports. At (4), traffic manager 408 can forward packets based on one or more multicast groups associated with the test packet. At (5), based on a configuration from control plane 402, ingress packet processing pipeline 404 can be configured with a forwarding table (e.g., fwding_table( )) to assign one or more multicast groups to the test packet based on an ingress port of the test packet. For example, match-action circuitry can access the forwarding table to assign one or more multicast groups to the test packet based on an ingress port of the test packet.

At (6), based on a configuration from control plane 402, ingress packet processing pipeline 404 can be configured with a checksum verify table (checksum_verify( )) to compare a checksum of the test packet with a checksum generated based on a replica packet. For example, match-action circuitry can access the checksum verify table to compare a checksum of the test packet with a checksum generated based on a replica packet.

At (7), based on a configuration from control plane 402, ingress packet processing pipeline 404 can be configured to transmit multicast packets to multiple ports in one or more egress pipelines of egress packet processing pipeline 410. For example, match-action circuitry can access the forwarding table to transmit multicast packets to multiple ports in one or more egress pipelines of egress packet processing pipeline 410.

Based on a configuration from control plane 402, a multicast group can be associated with one or more LAG groups and physical ports can be added to a LAG. Based on a configuration from control plane 402, a multicast group can be associated with one or more ECMP groups and physical ports can be added to an ECMP group. Based on a configuration from control plane 402, one or more multicast groups generate a single packet copy for a port in the group. Based on a configuration from control plane 402, one or more multicast groups generate multiple packet copies per port. Based on a configuration from control plane 402, a multicast database can be updated to include a tree node to identify a group of nodes, where a node is associated with one or more physical ports, ECMP group, or LAG group.

After testing setup, control plane 402 can generate one or more test packets of same or varying sizes with same or different header fields, same or different header field values, same or different payload content, same or different payload size, and apply one or more parameters specified in FIG. 3. Control plane 402 can provide the one or more test packets to ingress pipeline 404. The test packets can be Transmission Control Protocol (TCP) packets. One or more packets can have a fixed header format with pseudo-random payload data and TCP destination port number field value can be unique for a test packet so that different test packets have different TCP destination port number field values. The TCP destination port number can be a 16 bit field, although other values can be used to increase or decrease a number of test packet identifiers.

Control plane 402 can compute a checksum of test packets and program verification table 405 (e.g., checksum_verify( )) table with a checksum of one or more of the test packets. A checksum can include a hash of a packet to reduce a number of bits that identify a packet. For example, a CRC32 hash algorithm can be performed to generate a checksum. In some examples, a checksum can be a 16 bit value that is calculated over one or more header fields and/or one or more payload fields, although other sizes of checksum can be utilized.

Control plane 402 can calculate checksum per test packet and program table 405 before starting a test. In some examples, control plane 402 can store into table 405 one or more packet headers and checksum calculated over payload based on whether the forwarding pipeline can perform calculation of packet checksum (e.g., header and payload). The forwarding chip can be configured operate in store and forward mode to store an entire packet prior to start of egress of the packet. In some examples, control plane 402 can store into table 405 one or more packet headers and checksum calculated over one or more packet headers. For example, P4 exposes a Checksum( ) function to cause parser to perform checksum over one or more headers.

An example of table 405 can be as in Table 1.

TABLE 1

| TCP destination port | Checksum value | Checksum applied |
|---|---|---|
| Value | Computed value | Header, payload, |
| | | header + payload |

Traffic manager 408 can perform multicast operations for one or more test packets provided by control plane 402 that are designated to be multicast. Traffic manager 408 can assign the packet to a multicast group or groups. Traffic manager 408 can create copies of the test packet based on the ports in the multicast group and provide copies of the test packet to queues associated with the multiple ports of the multicast group.

Errors in replica packets can be identified based on a checksum of a replica packet being different from that of a base test packet. Table 405 can be accessible to pipeline 404 to verify that checksums of replica packets match that of the base test packet. In some examples, a checksum and check of multiple bits can be stored in table 405 and one or more of a checksum and multiple bits can be used to determine if a replica packet differs from the base test packet. Table 405 can associate a packet with a TCP destination port number and expected checksum number and/or other values or properties. Table 405 can be accessed using Table checksum_verify( ) Lookup key: (TCP destination port Number, Checksum).

For example, for packets received at ingress packet processing pipeline 404, an ingress parser or other circuitry can calculate a checksum value for a received packet (from control plane 402 or MAC 412) and store the checksum value in metadata associated with the packet. For the received packet, ingress packet processing pipeline 404 can perform lookups in table 405 to compare the calculated value with a value(s) in table 405 associated with the test packet and/or a counter of overall number of errors. For example, match-action circuitry in pipeline 404 can perform lookups in table 405 and comparison operations. For successful matches of the calculated value(s) with value(s) in table 405, the packet is considered to be unchanged by circuitry of the network interface device or include expected values and the packet can be provided to traffic manager 408. But, if the calculated value(s) do not match value(s) for the packet in table 405, ingress packet processing pipeline 404 can increment an error counter for the packet and/or a counter of overall number of errors. Use of a checksum or strict subset of values in the packet (e.g., less than all values of the packet) to determine whether content of the packet has changed can reduce computation and power used to determine whether content of the packet has changed. Identification of errors in replica packets based on checksum comparison can be performed at line-rate (e.g., peak packet egress rate supported by a port).

The packets of the multicast group can traverse egress pipeline 410 to media access control (MAC) circuitry 412. MAC 412 can receive packets of the multicast group and can cause the packets of the multicast group to loop back to a primary port and/or one or more secondary ports based on the MAC 412 being in loopback mode. MAC 412 can be in loopback mode based on configuration from control plane 402 during a test operation.

Looped back packets can be received by ingress pipeline 404. Packets arriving at primary port of ingress pipeline 404 can continue if there is a forwarding rule in a forwarding table (fwding_table( )). Ingress pipeline 404 can receive packets at one or more secondary ports. Ingress pipeline 404 can verify packets received through primary and secondary ports based on calculation of checksum and lookup in table 405. If checksums do not match, error counter for the test packet can be incremented and, in some cases, a counter of errors arising from replication of more than one test packet can be incremented. Ingress pipeline 404 packets arriving at one or more secondary ports as there is no forwarding rule for the packets. Packets can circulate through the forwarding element for an amount of time (e.g., 3 minutes or other amounts of time) to test multicast operations.

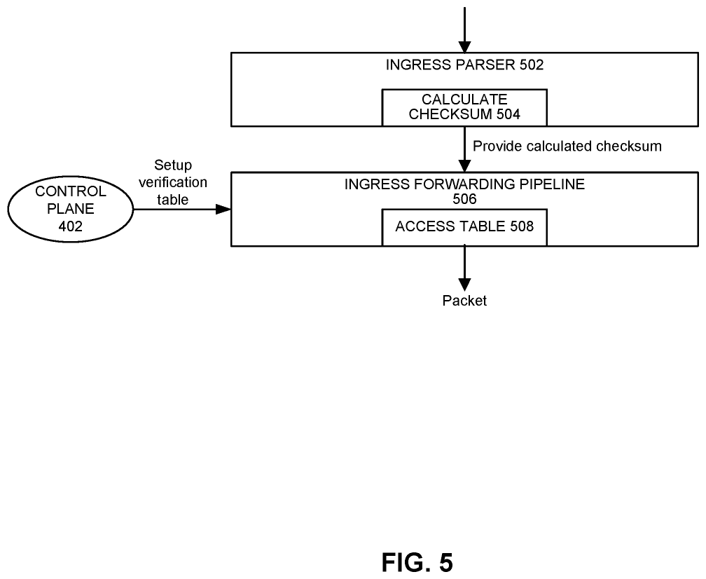

FIG. 5 depicts an example of checksum verify. Ingress parser 502 can include circuitry to calculate a checksum 504 on a received packet. The checksum can be calculated over one or more headers and/or payload of the packet.

Ingress forwarding pipeline 506 can receive the calculated checksum as metadata associated with the packet. Based on a configuration from control plane 402 in table 508, ingress forwarding pipeline 506 can include circuitry to compare the calculated checksum with the configured checksum in table 508. The circuitry to compare the calculated checksum with the configured checksum in table 508 can include match-action circuitry. A key used to identify an entry in table 508 can be a TCP destination port of the packet.

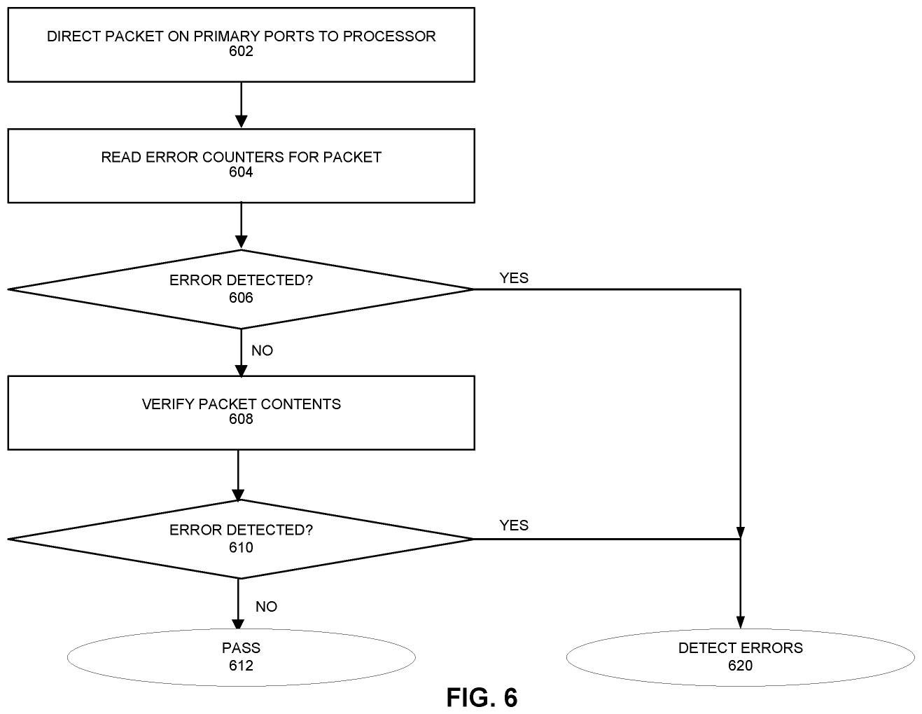

FIG. 6 depicts an example process for framework verification. The process can be performed while the network interface device is positioned in a laboratory or factory or while the network interface device is in use by a customer such as a in a datacenter or other environment. After a test time duration has passed, determination of errors can take place for test packets generated for multicast. For example, based on checksum utilized to identify errors in packets being merely one or more headers and not include payload, an additional check for errors can be performed using a host server processor (e.g., CPU). The additional check can be performed in a laboratory using a system level test (SLT) framework or while the forwarding element is deployed in the field used by a customer. In some examples, the additional check can be performed based on zero or more errors being detected based on the checksum being merely one or more headers and not include payload.

At 602, the control plane can configure the network interface device to cause packets received in primary ports to be directed to the CPU. For example, a control plane can add a forwarding rule in fwding_table( ) in an ingress pipeline to redirect packets received in primary ports to the CPU. The packets can be redirected to the CPU via a PCIe or CXL link. Multicast packet copies on secondary ports can be dropped in the forwarding pipeline.

A packet drain approach can be applied to provide packets with a TCP destination port number range to the CPU over a time duration (e.g., 100 milliseconds) to avoid buffer overflow. If the PCIe link speed is faster, more packets can be drained and total drain time can be reduced. For example, to stress a switch chip to its utmost, the framework can generate X number of test packets of random sizes. Packets with TCP destination port numbers between 1 to M can be provided to the CPU. Other packets can re-circulate through the circuitry. After Y milliseconds, packets with TCP destination port numbers M+1 to N can be provided to the CPU and so on. The packet verification also completes in that 1 second timeframe. The control plane can install a forwarding rule directing packets of a TCP destination port range to the CPU.

At 604, a test process (e.g., control plane) executing on the CPU can read checksum_verify( ) table counters to determine if a counter is non-zero. A non-zero counter indicates there was a checksum error detected by the forwarding element. At 606, based on non-zero errors detected, the process can proceed to 620, where the test is marked fail as errors were detected.

At 606, based on no errors detected, at 608, the test process can verify packets received against test packets originally provided by the control plane to the network interface device. All or a subset of bits in the test packets (e.g., header and payload) can be compared against the packets forwarded from the network interface device to the CPU. At 610, based on no errors being detected, the process can proceed to 612 and the diagnostic test is marked pass. Based on failing a test, the network interface device can be permitted to be provided to a customer or undergo other tests.

At 610, based on non-zero errors being detected, the process can proceed to 620, where the test is marked fail as errors were detected. Based on failing a test, the network interface device can be discarded or change of change design or manufacturing process of the forward element device. In some examples, if a network interface device is identified as defective while in a field of use such as use by a purchaser as in a data center, the network interface device can communicate with an orchestrator or administrator and the packet traffic can be routed to avoid the network interface device or the network interface device can be disabled from performing multicast operations. Reporting of errors from multicast operations can be communicated using in-network telemetry (INT) (e.g., Internet Engineering Task Force (IETF) draft-kumar-ippm-ifa-01, “Inband Flow Analyzer” (February 2019)) or other manner of transmitting telemetry.

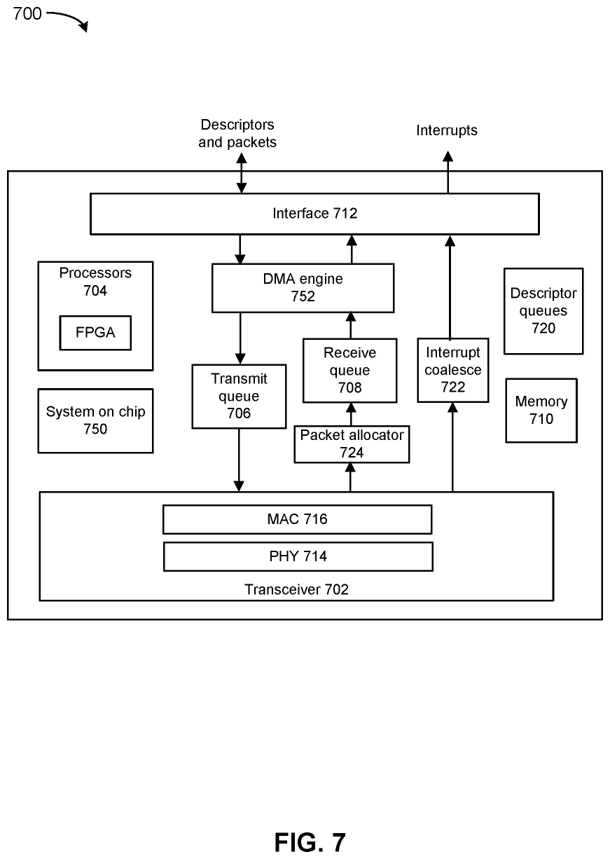

FIG. 7 depicts an example network interface device or packet processing device. In some examples, multicast operations of the network interface device can be tested, as described herein. In some examples, packet processing device 700 can be implemented as a network interface controller, network interface card, a host fabric interface (HFI), or host bus adapter (HBA), and such examples can be interchangeable. Packet processing device 700 can be coupled to one or more servers using a bus, PCIe, CXL, or DDR. Packet processing device 700 may be embodied as part of a system-on-a-chip (SoC) that includes one or more processors, or included on a multichip package that also contains one or more processors.

Some examples of packet processing device 700 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 700 can include transceiver 702, processors 704, transmit queue 706, receive queue 708, memory 710, and bus interface 712, and DMA engine 752. Transceiver 702 can be capable of receiving and transmitting packets in conformance with the applicable protocols such as Ethernet as described in IEEE 802.3, although other protocols may be used. Transceiver 702 can receive and transmit packets from and to a network via a network medium (not depicted). Transceiver 702 can include PHY circuitry 714 and media access control (MAC) circuitry 716. PHY circuitry 714 can include encoding and decoding circuitry (not shown) to encode and decode data packets according to applicable physical layer specifications or standards. MAC circuitry 716 can be configured to assemble data to be transmitted into packets, which include destination and source addresses along with network control information and error detection hash values.

Processors 704 can be any a combination of a: processor, core, graphics processing unit (GPU), field programmable gate array (FPGA), application specific integrated circuit (ASIC), or other programmable hardware device that allow programming of network interface 700. For example, a “smart network interface” can provide packet processing capabilities in the network interface using processors 704.

Processors 704 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 704, including its data plane, can be programmed based on one or more of: one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others. Processors 704 and/or system on chip 750 can execute instructions to configure and utilize one or more circuitry as well as check against violation against use configurations, as described herein.

Packet allocator 724 can provide distribution of received packets for processing by multiple CPUs or cores using timeslot allocation described herein or RSS. When packet allocator 724 uses RSS, packet allocator 724 can calculate a hash or make another determination based on contents of a received packet to determine which CPU or core is to process a packet.

Interrupt coalesce 722 can perform interrupt moderation whereby network interface interrupt coalesce 722 waits for multiple packets to arrive, or for a time-out to expire, before generating an interrupt to host system to process received packet(s). Receive Segment Coalescing (RSC) can be performed by network interface 700 whereby portions of incoming packets are combined into segments of a packet. Network interface 700 provides this coalesced packet to an application.

Direct memory access (DMA) engine 752 can copy a packet header, packet payload, and/or descriptor directly from host memory to the network interface or vice versa, instead of copying the packet to an intermediate buffer at the host and then using another copy operation from the intermediate buffer to the destination buffer.

Memory 710 can be any type of volatile or non-volatile memory device and can store any queue or instructions used to program network interface 700. Transmit queue 706 can include data or references to data for transmission by network interface. Receive queue 708 can include data or references to data that was received by network interface from a network. Descriptor queues 720 can include descriptors that reference data or packets in transmit queue 706 or receive queue 708. Bus interface 712 can provide an interface with host device (not depicted). For example, bus interface 712 can be compatible with PCI, PCI Express, PCI-x, Serial ATA, and/or USB compatible interface (although other interconnection standards may be used).

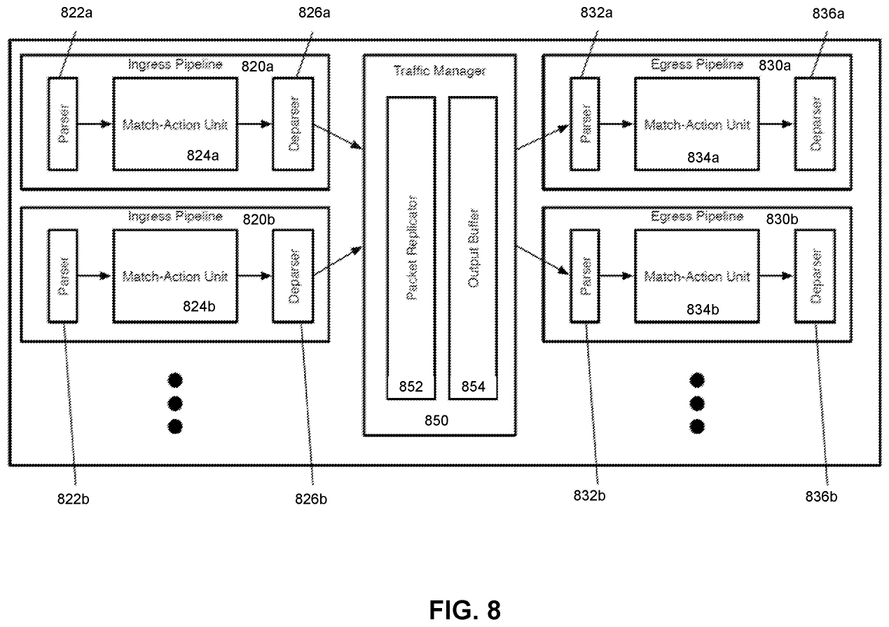

FIG. 8 depicts an example packet processing pipeline that can be used in a switch, network device, or packet processing device. Multicast operations of the packet processing pipeline can be tested, as described herein. A packet processing pipeline several ingress pipelines 820, a traffic management unit (referred to as a traffic manager) 850, and several egress pipelines 830. Though shown as separate structures, in some examples the ingress pipelines 820 and the egress pipelines 830 can use the same circuitry resources. In some examples, the pipeline circuitry is configured to process ingress and/or egress pipeline packets synchronously, as well as non-packet data. That is, a particular stage of the pipeline may process any combination of an ingress packet, an egress packet, and non-packet data in the same clock cycle. However, in other examples, the ingress and egress pipelines are separate circuitry. In some of these other examples, the ingress pipelines also process the non-packet data.

Configuration of operation of packet processing pipelines, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In some examples, in response to receiving a packet, the packet is directed to one of the ingress pipelines 820 where an ingress pipeline which may correspond to one or more ports of a hardware forwarding element. After passing through the selected ingress pipeline 820, the packet is sent to the traffic manager 850, where the packet is enqueued and placed in the output buffer 854. In some examples, the ingress pipeline 820 that processes the packet specifies into which queue the packet is to be placed by the traffic manager 850 (e.g., based on the destination of the packet or a flow identifier of the packet). The traffic manager 850 then dispatches the packet to the appropriate egress pipeline 830 where an egress pipeline may correspond to one or more ports of the forwarding element. In some examples, there is no necessary correlation between which of the ingress pipelines 820 processes a packet and to which of the egress pipelines 830 the traffic manager 850 dispatches the packet. That is, a packet might be initially processed by ingress pipeline 820b after receipt through a first port, and then subsequently by egress pipeline 830a to be sent out a second port, etc.

A least one ingress pipeline 820 includes a parser 822, plural match-action units (MAUs) 824, and a deparser 826. Similarly, egress pipeline 830 can include a parser 832, plural MAUs 834, and a deparser 836. The parser 822 or 832, in some examples, receives a packet as a formatted collection of bits in a particular order, and parses the packet into its constituent header fields. In some examples, the parser starts from the beginning of the packet and assigns header fields to fields (e.g., data containers) for processing. In some examples, the parser 822 or 832 separates out the packet headers (up to a designated point) from the payload of the packet, and sends the payload (or the entire packet, including the headers and payload) directly to the deparser without passing through the MAU processing.

MAUs 824 or 834 can perform processing on the packet data. In some examples, MAUs includes a sequence of stages, with a stage including one or more match tables and an action engine. A match table can include a set of match entries against which the packet header fields are matched (e.g., using hash tables), with the match entries referencing action entries. When the packet matches a particular match entry, that particular match entry references a particular action entry which specifies a set of actions to perform on the packet (e.g., sending the packet to a particular port, modifying one or more packet header field values, dropping the packet, mirroring the packet to a mirror buffer, etc.). The action engine of the stage can perform the actions on the packet, which is then sent to the next stage of the MAU. For example, MAU(s) can be used to determine whether to migrate data to another memory device and select another memory device, as described herein.

Deparser 826 or 836 can reconstruct the packet using a packet header vector (PHV) or other metadata as modified by the MAU 824 or 834 and the payload received directly from the parser 822 or 832. The deparser can construct a packet that can be sent out over the physical network, or to the traffic manager 850. In some examples, the deparser can construct this packet based on data received along with the PHV that specifies the protocols to include in the packet header, as well as its own stored list of data container locations for possible protocol's header fields.

Traffic manager 850 can include a packet replicator 852 and output buffer 854. In some examples, the traffic manager 850 may include other components, such as a feedback generator for sending signals regarding output port failures, a series of queues and schedulers for these queues, queue state analysis components, as well as additional components. The packet replicator 852 of some examples performs replication for broadcast/multicast packets, generating multiple packets to be added to the output buffer (e.g., to be distributed to different egress pipelines).

Output buffer 854 can be part of a queuing and buffering system of the traffic manager in some examples. The traffic manager 850 can provide a shared buffer that accommodates any queuing delays in the egress pipelines. In some examples, this shared output buffer 854 can store packet data, while references (e.g., pointers) to that packet data are kept in different queues for egress pipeline 830. The egress pipelines can request their respective data from the common data buffer using a queuing policy that is control-plane configurable. When a packet data reference reaches the head of its queue and is scheduled for dequeuing, the corresponding packet data can be read out of the output buffer 854 and into the corresponding egress pipeline 830. In some examples, packet data may be referenced by multiple pipelines (e.g., for a multicast packet). In this case, the packet data is not removed from this output buffer 854 until references to the packet data have cleared their respective queues.

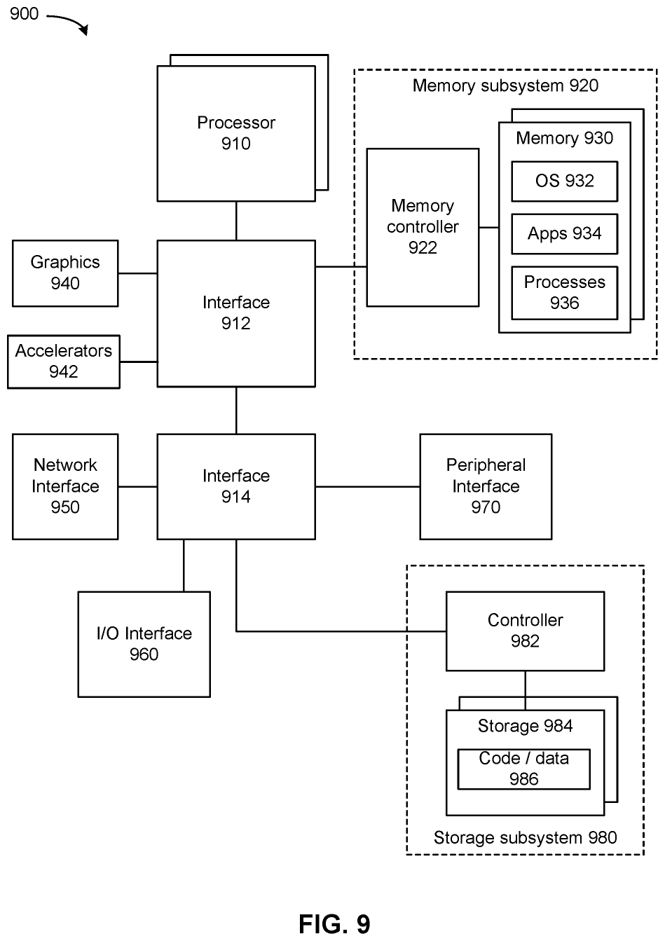

FIG. 9 depicts a system. In some examples, operation of programmable pipelines of network interface 950 can configured to test whether network interface 950 can properly perform multicast operations, as described herein. System 900 includes processor 910, which provides processing, operation management, and execution of instructions for system 900. Processor 910 can include any type of microprocessor, central processing unit (CPU), graphics processing unit (GPU), XPU, processing core, or other processing hardware to provide processing for system 900, or a combination of processors. An XPU can include one or more of: a CPU, a graphics processing unit (GPU), general purpose GPU (GPGPU), and/or other processing units (e.g., accelerators or programmable or fixed function FPGAs). Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a display that provides an output to a user. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a programmable or fixed function offload engine that can be accessed or used by a processor 910. For example, an accelerator among accelerators 942 can provide data compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 942 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

Applications 934 and/or processes 936 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from another, allowing virtual machines to run Linux®, Windows® Server, VMware ESXi, and other operating systems on the same underlying physical host. In some examples, an operating system can issue a configuration to a data plane of network interface 950.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others. In some examples, OS 932 or driver can advertise to one or more applications or processes capability of network interface 950 to test whether network interface 950 can properly perform multicast operations. In some examples, OS 932 or driver can enable or disable or limit capabilities of network interface 950 to perform testing of multicast operations.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

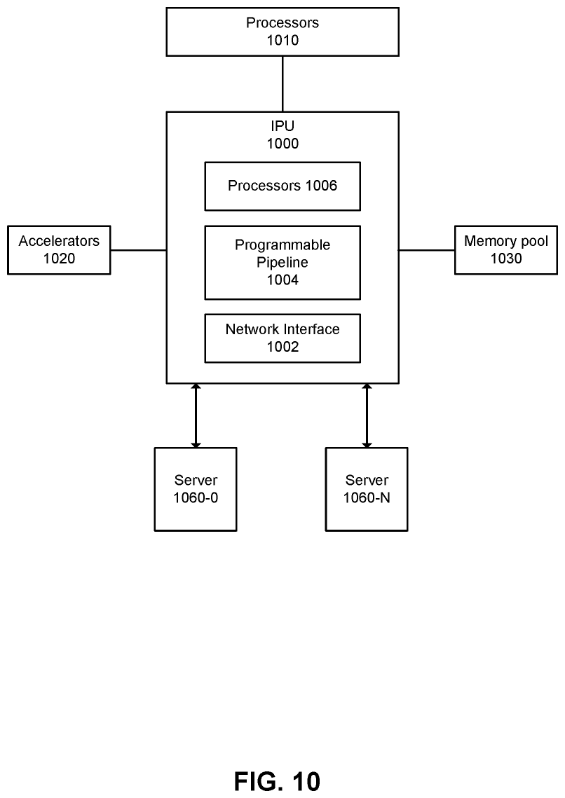

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 can receive data from a remote device, which can include storing received data into memory. In some examples, network interface 950 or network interface device 950 can refer to one or more of: a network interface controller (NIC), a remote direct memory access (RDMA)-enabled NIC, SmartNIC, router, switch (e.g., top of rack (ToR) or end of row (EoR)), forwarding element, infrastructure processing unit (IPU), or data processing unit (DPU). An example IPU or DPU is described at least with respect to FIG. 10.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 900. More specifically, power source typically interfaces to one or multiple power supplies in system 900 to provide power to the components of system 900. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. A die-to-die communications can utilize Embedded Multi-Die Interconnect Bridge (EMIB) or an interposer.

In an example, system 900 can be implemented using interconnected compute sleds of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

FIG. 10 depicts an example system. In this system, IPU 1000 manages performance of one or more processes using one or more of processors 1006, processors 1010, accelerators 1020, memory pool 1030, or servers 1040-0 to 1040-N, where N is an integer of 1 or more. In some examples, processors 1006 of IPU 1000 can execute one or more processes, applications, VMs, containers, microservices, and so forth that request performance of workloads by one or more of: processors 1010, accelerators 1020, memory pool 1030, and/or servers 1040-0 to 1040-N. IPU 1000 can utilize network interface 1002 or one or more device interfaces to communicate with processors 1010, accelerators 1020, memory pool 1030, and/or servers 1040-0 to 1040-N. IPU 1000 can utilize programmable pipeline 1004 to process packets that are to be transmitted from network interface 1002 or packets received from network interface 1002. In some examples, programmable pipelines 1004 can be configured to test whether network interface 950 can properly perform multicast operations, as described herein.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, application program interface (API), instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples, and includes an interface and a network interface device coupled to the interface and comprising circuitry that is to: receive a packet; replicate the packet based on a multicast configuration; and determine a number of replicate packets that differ from the received packet.

Example 2 includes one or more examples, wherein the circuitry is to receive hash value that comprises a hash of a portion of the packet and the circuitry is to determine a hash value of a portion of the replicated packet.

Example 3 includes one or more examples, wherein the determine a number of replicate packets that differ from the received packet is based on the received hash value and the determined hash value.

Example 4 includes one or more examples, wherein the hash value of the packet is based on at least one header of the packet.

Example 5 includes one or more examples, wherein the hash value of the packet is based on at least one header and a portion of a payload of the packet.

Example 6 includes one or more examples, wherein the determine a number of replicate packets that differ from the received packet is performed at line-rate of the network interface device.

Example 7 includes one or more examples, wherein the circuitry is configured to replicate the packet based on a multicast configuration and determine a number of replicate packets that differ from the received packet based on a configuration consistent with one or more of: Protocol-independent Packet Processors (P4), Software for Open Networking in the Cloud (SONiC), Broadcom® Network Programming Language (NPL), NVIDIA® CUDA®, NVIDIA® DOCA™, or Infrastructure Programmer Development Kit (IPDK).

Example 8 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).

Example 9 includes one or more examples, and includes a server communicatively coupled to the network interface device to configure the circuitry to replicate the packet based on a multicast configuration and determine a number of replicate packets that differ from the received packet.

Example 10 includes one or more examples, and includes a non-transitory computer-readable medium comprising instructions stored thereon, that if executed by one or more processors, cause the one or more processors to: configure a network interface device to: replicate a packet based on a multicast configuration and determine a number of replicate packets that differ from the received packet.

Example 11 includes one or more examples, wherein the multicast configuration is based on one or more of: a link aggregation group (LAG), an equal-cost multi-path routing (ECMP) group, packet size, single packet copy or multiple packet copy per port, single tree node or multiple tree nodes per multicast group, or cross pipeline packet traversal.

Example 12 includes one or more examples, and includes instructions stored thereon, that if executed by one or more processors, cause the one or more processors to: configure the network interface device to: store a value that comprises a hash of a portion of the packet and determine a hash of a portion of the replicated packet.

Example 13 includes one or more examples, wherein the determine a number of replicate packets that differ from the received packet is based on the stored hash value and the determined hash value.

Example 14 includes one or more examples, wherein the hash of a portion of the packet is based on at least one header of the packet.

Example 15 includes one or more examples, wherein the hash of a portion of the packet is based on at least one header and a portion of a payload of the packet.

Example 16 includes one or more examples, wherein the network interface device is configured to replicate the packet based on a multicast configuration and determine a number of replicate packets that differ from the received packet based on a configuration consistent with one or more of: Protocol-independent Packet Processors (P4), Software for Open Networking in the Cloud (SONiC), Broadcom® Network Programming Language (NPL), NVIDIA® CUDA®, NVIDIA® DOCA™, or Infrastructure Programmer Development Kit (IPDK).

Example 17 includes one or more examples, and includes a method that includes determining whether a network interface device is defective based on: a network interface device replicating a packet based on a multicast configuration and determining a number of replicate packets that differ from the received packet.

Example 18 includes one or more examples, wherein the determining whether a network interface device is defective is based on a non-zero number of replicate packets that differ from the received packet.

Example 19 includes one or more examples, wherein the determining a number of replicate packets that differ from the packet is based on a received hash value and a hash value calculated on a portion of a replicate packet.

Example 20 includes one or more examples, wherein the hash value calculated on the replicate packet is based on at least one header and a portion of a payload of the packet.

What is claimed is:

1. An apparatus comprising:
an interface and
a network interface device coupled to the interface and comprising circuitry that is to:
receive a packet;
replicate the packet based on a multicast configuration; and
determine a number of replicate packets that differ from the received packet.

2. The apparatus of claim 1, wherein
the circuitry is to receive hash value that comprises a hash of a portion of the packet and
the circuitry is to determine a hash value of a portion of the replicated packet.

3. The apparatus of claim 2, wherein the determine a number of replicate packets that differ from the received packet is based on the received hash value and the determined hash value.

4. The apparatus of claim 2, wherein the hash value of the packet is based on at least one header of the packet.

5. The apparatus of claim 2, wherein the hash value of the packet is based on at least one header and a portion of a payload of the packet.

6. The apparatus of claim 1, wherein the determine a number of replicate packets that differ from the received packet is performed at line-rate of the network interface device.

7. The apparatus of claim 1, wherein the circuitry is configured to replicate the packet based on a multicast configuration and determine a number of replicate packets that differ from the received packet based on a configuration consistent with one or more of: Protocol-independent Packet Processors (P4), Software for Open Networking in the Cloud (SONiC), Broadcom® Network Programming Language (NPL), NVIDIA® CUDA®, NVIDIA® DOCA™, or Infrastructure Programmer Development Kit (IPDK).

8. The apparatus of claim 1, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).

9. The apparatus of claim 1, comprising a server communicatively coupled to the network interface device to configure the circuitry to replicate the packet based on a multicast configuration and determine a number of replicate packets that differ from the received packet.

10. A non-transitory computer-readable medium comprising instructions stored thereon, that if executed by one or more processors, cause the one or more processors to:
configure a network interface device to:
replicate a packet based on a multicast configuration and
determine a number of replicate packets that differ from a received packet.

11. The computer-readable medium of claim 10, wherein the multicast configuration is based on one or more of: a link aggregation group (LAG), an equal-cost multi-path routing (ECMP) group, packet size, single packet copy or multiple packet copy per port, single tree node or multiple tree nodes per multicast group, or cross pipeline packet traversal.

12. The computer-readable medium of claim 10, comprising instructions stored thereon, that if executed by one or more processors, cause the one or more processors to:
configure the network interface device to:
store a value that comprises a hash of a portion of the packet and
determine a hash of a portion of the replicated packet.

13. The computer-readable medium of claim 12, wherein the determine a number of replicate packets that differ from the received packet is based on the stored hash value and the determined hash value.

14. The computer-readable medium of claim 12, wherein the hash of a portion of the packet is based on at least one header of the packet.

15. The computer-readable medium of claim 12, wherein the hash of a portion of the packet is based on at least one header and a portion of a payload of the packet.

16. The computer-readable medium of claim 12, wherein the network interface device is configured to replicate the packet based on a multicast configuration and determine a number of replicate packets that differ from the received packet based on a configuration consistent with one or more of: Protocol-independent Packet Processors (P4), Software for Open Networking in the Cloud (SONiC), Broadcom® Network Programming Language (NPL), NVIDIA® CUDA®, NVIDIA® DOCA™, or Infrastructure Programmer Development Kit (IPDK).

17. A method comprising:
determining whether a network interface device is defective based on:
a network interface device replicating a packet based on a multicast configuration and
determining a number of replicate packets that differ from a received packet.

18. The method of claim 17, wherein the determining whether a network interface device is defective is based on a non-zero number of replicate packets that differ from the received packet.

19. The method of claim 17, wherein the determining a number of replicate packets that differ from the packet is based on a received hash value and a hash value calculated on a portion of a replicate packet.

20. The method of claim 17, wherein the hash value calculated on the replicate packet is based on at least one header and a portion of a payload of the packet.
